(19) United States
(12) Patent Application Publication
(10) Pub. No.: US 2006/0127301 A1
(43) Pub. Date: Jun. 15, 2006

(54) Process for the preparation of cabr2 hydrates and uses thereof

(76) Inventors: Raphael Elitzur, Mevaseret Zion (IL); Baruch Grinbaum, Tivon (IL); Miriam Freiberg-Bergstein, Omer (IL)

Correspondence Address: Kevin D McCarthy;Roach Brown McCarthy & Gruber, 1620 Liberty Building, Buffalo, NY, 14202, US

(21) Appl. No.: 10/536,198

(22) PCT Filed: Dec. 1, 2003
(86) PCT No.: PCT/IL03/01018

§ 371 Date: Dec. 1, 2005

(30) Foreign Application Priority Data
Dec. 2, 2002 (IL) 153232

(51) Int. Cl. C01F 11/34

(52) U.S. Cl. 423/497

(57) ABSTRACT

A process for the preparation of Solid Calcium Bromide Hydrates comprises preparing a highly concentrated Calcium Bromide solution from an initial solution having a lower concentration, bringing it into contact with a cold surface, whereby solid Calcium Bromide hydrates form on said surface, and detaching said solid hydrates from said surface. The concentration of the initial solution is not higher than 60 wt %, typically 52 wt %, and is brought to from 65 to 78 wt %. The said Calcium Hydrates are mainly tetrahydrate Calcium Bromide. The Solid Calcium Hydrates have many uses in the processing of oil wells, for instance preparation of completion fluids, work-over fluids or drill-in fluids in the processing of wells, restoring already used and/or depleted such fluids to the desired, original density. They also have other uses, particularly for soil remediation.

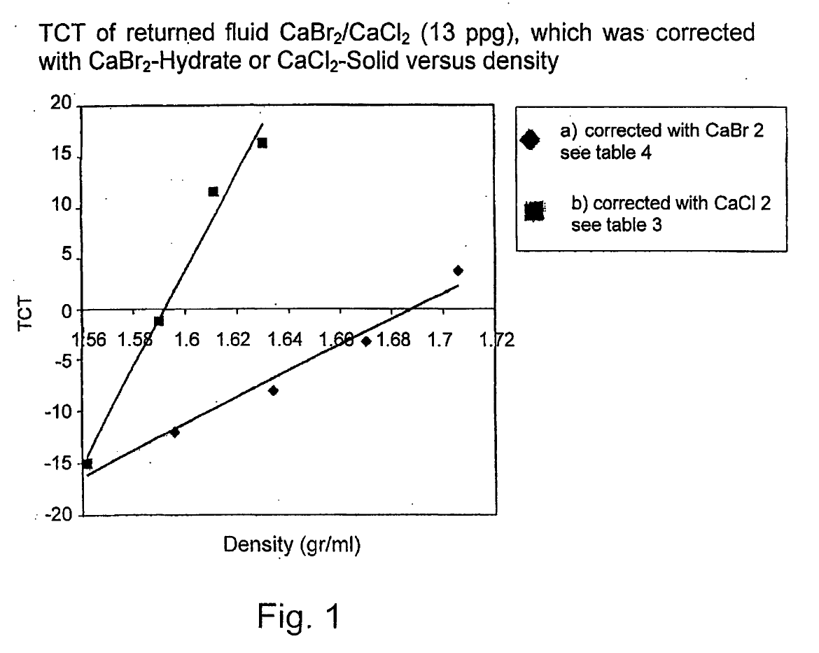

### FIELD OF THE INVENTION

The present invention relates to the production of Calcium Bromide hydrates and their uses for the preparation of clear brines with a desired density for fluids used in oil and gas field applications, soil remediation or for any other use, and for increasing the density of used or fresh clear brines.

### BACKGROUND OF THE INVENTION

Calcium Bromide (CaBr₂) solution is utilized either alone or in combination with other fluids for use in completion, work-over, and drill-in applications for oil/gas fields. Completion fluids are fluids that are pumped to the well in order to conduct operations after the initial drilling of the well with drilling fluid. Work-over fluids are fluids that are used after the well has produced oil and/or gas. With the development of horizontal well bores, “drill-in” fluids that are based on low concentration of solid fluids are commonly used for drilling the productive interval instead of conventional high solid concentration drilling fluids. The objective of using these fluids is to reduce the incidence of formation damage resulting in increased productivity of the well. The main functions of these fluids are to remove solids from the well bore and to control the formation pressure during the operation of drilling, cementing, perforating, stimulation, fracturing, etc.

Among other important functions of fluids are:
to deposit the well bore with a filter cake (wall building) to control fluid loss and prevent sticking of the tubulars;
to suspend the cuttings during drilling interruptions; and
to lubricate the drill bit.

To provide all those functions the drilling fluid should be maintained to retain the desired characteristics, rheological properties and density. However fluids based on a high concentration of salt are hygroscopic and therefore tend to become diluted especially if coming into physical contact with other fluids.

The CaBr₂ is mainly supplied as a 52% CaBr₂ solution and in a solid state which contains 95% CaBr₂. A 52% CaBr₂ solution is saturated below −10° C. The melting point of the solid state CaBr₂ is about 700° C., and it is highly hygroscopic. In the open air, the solid CaBr₂ absorbs air humidity and dissolves.

One of the goals of this invention is to provide solid forms of CaBr₂ hydrates which may be effectively used to fix the solution concentration of depleted CaBr₂ solutions that had undergone dilution, and in particular tri- and tetra-CaBr₂ hydrates. The CaBr₂ hydrates are barely mentioned in the literature. There are, however, a number of known existing CaBr₂ hydrates, such as monohydrate, dihydrate, trihydrate, tetrahydrate, and hexahydrate.

Seven hydrates of CaBr2 with 6, 4, 3, 2, 1.5, 1, and 0.5 moles of H₂O are described by Gmelins Handbuch der Anorg (Chemie, 8, Aufl. Verlag Chemie, Weinheim 1957. System-Nummer 28, Teil B., Lief 2). However, the phase equilibrium examination of the water-salt system only proved the existence of hexa, tetra, and dihydrates (H. Bassett et al. “The Ternary Systems Constituted by Mercuric Chloride, Water and an Alkaline Earth Chloride or Cupric Chloride.” J. Chem. Soc. 1933, 151-164). According to J. Millikan (Diss. Leiden (1914), 31) Tetrahydrate (CaBr₂.4H₂O) exits at a temperature range of 40° C. to 105° C.

The molecular weight of CaBr₂ Trihydrate (CaBr₂.3H₂O) is 253.96, and according to X. Roques (J. Pharm. Chim. 6 (1895), 301) it appears in the form of Rhombic plates, which were described as very deliquescent. The magnetic susceptibility of CaBr₂ Trihydrate according to M. D. Prasad et al. (Pr. Indian Accad. Sci., 20 (1945), 224) is 0.453×10-6 cgs, and according to C. O. Curtman (JACS 16 (1894), 621) its melting point is about 80-81° C.

Crystallization experiments carried out on a 70% calcium bromide solution are described by P. Kuznetsov (“The Hydrates of the Halogen Salts of Calcium”, J. Russ. Phys. Chem. Soc. 41, 367-79 (1909)). A hydrate having the formula CaBr₂.4H₂O is introduced in this report, according to which, this new hydrate showed no transformations, although the crystallization phenomenon indicated a possible transition. It was also stated in this report that the transformation into the hexahydrate takes place at 55° C. However, the existence of trihydrates of halides was assumed as being improbable.

A study of the dehydration of hydrated calcium and strontium bromides and iodides by thermogravimetry and differential analysis is described by E. Buzagh-Gere et al. (“Investigation of Dehydration Process, II. Processes Preceding Dehydration of Alkaline Earth Halides.”, J. Therm. Anal. 10 (1976), 89-98.) Thermogravimetric (TG) curves that were taken while using a labyrinth crucible showed the presence of a nearly stoichiometric CaBr₂.4H₂O. The Differential Thermal Analysis (DTA) of CaBr₂.4H₂O showed that the peak of CaBr₂ hexahydrate melting appears at 32.5° C., and that of an endothermic (possibly CaBr₂.4H₂O) transformation occurs at about 51-52° C.

The dehydration process of CaBr₂ hexahydrate using a so-called quasi isothermal-quasi isobaric thermogravimetric method, is described in J. Paulik et al. (“Thermogravimetric Examination of the Dehydration Process of Calcium Bromide Hydrate under Quasi Isothermal and Quasi Isobaric Conditions.”, Thermochimica Acta, 31 (1979), 93-100). This report describes that in a self-generated atmosphere (using a labyrinth crucible) the path of the dehydration process was indicated by the intermediate formation of tetra-, di- and monohydrates.

The experimental melting enthalpies and entropies of a great number of salt hydrates (MX-nH₂O) are reviewed and/or determined by Differential Scanning Calorimetry (DSC), by J. Guion et al. (“Critical Examination and Experimental Determination of Melting Enthalpies and Entropies of Salt Hydrates.”, Thermochimica Acta, 67 (1983), 167-179.) In this report, experimental and theoretical correlations and evaluations proposed for melting entropies are correlated with the number of water molecules. A theoretical equation for the entropy of fusion is given, (ΔSₘ)_{hydrate}=ΔSₘ(MX)+nΔSₘ(H₂O), wherein ΔSₘ is the molar entropy of melting for CaBr₂ hexahydrate. It should be noted that no basis was given in this report for the existence of a trihydrate CaBr₂.

However, the prior art does not describe a process for making the said hydrates and, in particular, CaBr₂ trihydrate and/or tetrahydrate. Also, the prior art fails to provide uses of CaBr₂ hydrates. Calcium Bromide 95% (an irritant) is a solid powder. When it is poured into mixing tanks, some of the powder can become airborne, which requires the use of masks and protective equipment for workers. Calcium Bromide hydrate is present in flakes and is less likely to become airborne. Calcium Bromide 95% does not have any water and is therefore more reactive (exothermic reaction), when added to aqueous solutions of CaBr₂, than Calcium Bromide hydrate.

14.2 ppg Calcium Bromide is a standard solution. If a fluid having a lower density, e.g. 13 ppg is needed for a specific well, it can be obtained e.g. by adding Calcium Chloride solution having a density of 11.8 ppg (a standard solution) or by adding water. If a fluid having a higher density is needed for another well, a higher density fluid may be added, such as Calcium Chloride Solid (94-97%). Depleted brines, having too low a density, can be returned to the desired density by the addition of Calcium Bromide or a sufficiently concentrated solution of Calcium Bromide, but this is often not economical. It is also possible to add Calcium Chloride Solid to the depleted brine, but this will result in a fluid with a high True Crystallization Temperature (TCT)

It is a purpose of the present invention to provide forms of solid state of CaBr₂ hydrates and processes for their production.

It is another purpose of the present invention to provide an additive for raising the density of completion fluids, work-over fluids, and drill-in fluids, to obtain such fluids that contain less Calcium Chloride than comparable fluids having the same density, whereby a lower True Crystallization Temperature (TCT) is obtained. The lower TCT will allow the fluids to be used in winter and in all cold areas.

It is a further purpose of the present invention to provide such solid hydrates that are particularly adapted for returning depleted/diluted drilling fluids to the desired concentration, can be used for soil remediation, and can have other uses.

Other objects and advantages of the invention will become apparent as the description proceeds.

### SUMMARY OF THE INVENTION

The CaBr₂ hydrates prepared and/or dissolved and/or used according to the invention need not have a single degree of hydration and may, and generally will, be mixtures of differently hydrated compounds, tetrahydrate generally being the major component. Therefore it should be understood that the term “hydrates”, as used herein, comprises any mixture of differently hydrated compounds as well as an individual compound having a given degree of hydration or products mainly but not solely consisting of one such individual compound.

The present invention, in one of its aspects, provides a process for manufacturing Calcium Bromide hydrates. The process preferably comprises preparing a highly concentrated Calcium Bromide solution from an initial solution having a lower concentration, bringing it into contact with a cold surface, whereby solid Calcium Bromide hydrates form on said surface, and detaching said solid hydrates from said surface. The solids of the present invention are tetra- or mixed hydrates, and this should always be understood. Although it could be conceived to use different solvents, and this possibility is comprised in the scope of the invention, considerations of cost render the use of water as a solvent practically inevitable.

The concentration of the initial Calcium Bromide solution may be from 1 to 60 wt %. A particularly preferred concentration is close to or equal to the standard concentration, which is 52 wt %. The concentration of the highly concentrated solution is between 65 and 78 wt %. The temperature of the solid surface should be from −15 to +40° C. and preferably from 5 to 25° C. The solid surface is the surface of a body having any convenient structure, for example rotating drum (flaker) or horizontal belt with one or more plates or one or more filaments or yarns, and the body is preferably made of metal, e.g. SS-steel, Monel, Titanium or Hastelloy, or of polymers, rubber and the like. Said body is desirably recovered after detaching the solid hydrates from it and reused. The solid hydrates either fall off the solid surface by gravitation force or are detached using a scraper in the bottom of the drum or the end of the belt. Other details concerning the solid surface and its use will be set forth hereinafter.

The solid Calcium Bromide hydrates may have, in part or entirely, a crystalline structure, but this is not essential for the invention.

The Calcium Bromide hydrates are preferably tetrahydrate.

Another aspect of the invention are the solid CaBr₂ hydrates, having a concentration of CaBr₂ of not less than 65% (hexahydrate) and no more than 78%, i.e. near to the equivalent of trihydrate, and preferably from 70 to 75%. Their density is not less than 2.1 gr/ml, and typically between 2.15 and 2.3 gr/ml. All the percentages in this description and claims are by weight, unless otherwise specified.

Another aspect of the invention is a process for raising the density of Calcium Bromide solutions by adding CaBr₂ hydrates to said solutions. This is particularly useful when the Calcium Bromide solutions are depleted and therefore do not have the density required for their use. The expression “Calcium Bromide solutions” includes solutions containing salts other than Calcium Bromide, particularly Calcium Chloride. Said process includes adding, besides CaBr₂ hydrates, other density raising additives, e.g. Solid Calcium Chloride or solid Calcium Bromide or high concentration solutions of this latter.

A further aspect of the invention is the use of solid CaBr₂ hydrates for preparation of clear brines (completion fluids, work-over fluids, drill-in fluids) in the processing of oil wells and the like, in soil remediation (remedying contamination of a subsurface environment) or for any other use, and their use for restoring already used and therefore depleted drilling fluids (completion fluids, work-over fluids, drill-in fluids) to or close to the desired, original density, and for any other use. In restoring used drilling fluids by the addition of fresh solution it is clearly important to use materials as concentrated as possible, in order to reduce/minimize the solvent water that will be introduced as part of the operation.

### BRIEF DESCRIPTION OF THE DRAWINGS

The drawing is a diagram showing the True Crystallization Temperature (TCT) of returned fluids as a function of density.

### DETAILED DESCRIPTION OF PREFERRED EMBODIMENTS

CaBr₂ crystallizes in a few hydrate forms. The common forms are tetra- and hexahydrate. The hexahydrate contains 65% CaBr₂, the tetrahydrate contains 73% CaBr₂, and the trihydrate 79% CaBr₂. The existence of di- and trihydrates is questionable and they are mentioned as hypothetical species.

The hydrates are solid in ambient temperature, and their melting/saturation point rises with the decreasing number of water molecules. Table 1 details the calculated molecular weight and concentration of CaBr₂ (%) of CaBr₂ hydrates.

TABLE 1

| | Molecular | Concentration |
|---|---|---|
| Hydrate | Weight | CaBr₂ (%) |
| CaBr₂.6H₂O | 308 | 65 |
| CaBr₂.4H₂O | 272 | 73.5 |
| CaBr₂.3H₂O | 254 | 78.7 |
| CaBr₂.2H₂O | 236 | 85 |
| CaBr₂.H₂O | 218 | 91.7 |

The hexahydrate CaBr₂.6H₂O melts at temperatures below 40° C., and is not convenient as it may melt during storage and/or delivery. Its specific gravity is 2.1. The melting point of the tetrahydrate CaBr₂.4H₂O is 80° C. Its specific gravity is 2.2.

Table 2 gives the specific gravity and melting point of a number of CaBr₂ solutions having different concentrations.

TABLE 2

| | | Concentration |
|---|---|---|
| Specific Gravity | M.P. (° C.) | (% CaBr₂) |
| 2.1 | 62-66 | 72.9 |
| 2.09 | 80 | 73.4 |
| 2.17 | 112 | 75.9 |
| 2.29 | 135 | 77.2 |
| 2.30 | 136 | 77.8 |
| 2.31 | 172 | 78.5 |

The CaBr₂ solution can be obtained by evaporation of the excess water from a less concentrated, preferably an aqueous solution of CaBr₂. The evaporation can be carried out by means of a single or multiple effect evaporator, at temperatures between 80-160° C. and pressure between 1-100 KPa (0.01-1 atm.).

When a thin layer of the concentrated solution is poured on a cold solid surface, it solidifies and forms brittle CaBr₂ hydrate flakes. The cold solid surface is the surface of a body the material and structure of which are preferably chosen to facilitate the detachment of the said flakes from it, its cooling and its re-use. For these purposes, flexible bodies, such as belts, strips or cables, preferably of metal, which can be recirculated in and out of the CaBr₂ solution, are conveniently used. They can be cooled in any convenient way, e.g. with air, cooling water or brine. The solid surface may be part of known apparatus, such as e.g. flakers or pestillators. The flakes can be packed in a dry atmosphere and stored in sealed bags, e.g. double plastic bag. They preferably have thicknesses of 0.1-10 mm and areas from 0.1 to 100 cm²

The free flowing flakes may easily and readily be added as such to an existing solution of drilling fluid (either fresh or recycled) in order to increase its specific gravity or may be dissolved in water for use as fresh drilling fluids of the required specific gravity. Due to their very high specific gravity and concentration of CaBr₂, they can increase significantly the specific gravity either of depleted brine, which was recovered from a well, or of a fluid which was found to be too dilute. It should be understood that for these uses it is not necessary that the CaBr₂ hydrates be prepared by the method of this invention. If they had been prepared by another method, their use as herein set forth would still be comprised within the scope of the invention.

The process for preparing the solid CaBr₂ hydrates of the following examples preferably comprises the following steps. The starting solution of CaBr₂, e.g. having a concentration of 52 wt %, is evaporated under a suitable combination of temperature and pressure, to obtain the required concentration. For example, in order to obtain a pure tetrahydrate, i.e. 73.5% CaBr₂, the evaporation took place at 134° C. under pressure of 8 KPa (80 mbar).

### EXAMPLE 1

100 kg of CaBr₂ 52% were introduced into a 250 L agitated glass lined reactor. Vacuum of 80 mbar was applied and then the reactor was heated up to 13520 C. The resulting solution/melt contained 73.5% CaBr₂ . The melt was poured on a Hastelloy C drum of a 0.1 m² flaker, at a rate of 15-60 kg/h. The drum rotated with the speed of 1-3 rpm, and was cooled by brine with a temperature between from 10° C. to +25° C. The liquid solidified homogeneously over the drum, in a layer 2-7 mm thick, depending on the feed rate and the speed of the drum. The solid was removed from the surface by a scratching blade. Most of the flakes had the length of 0.5-5 cm. About 10% were obtained as dust, i.e. particles below 1 mm.

### EXAMPLE 2

The melt obtained as in Example 1 was poured on a horizontal Hastelloy C belt of solidifier.

The belt was 50 cm wide and 10 m long. The flow rate of the feed was between 1000 and 2500 kg/hr. About 80% of the melt solidified within the first 5 meters of the belt. The temperature of the melt was 130° C. The belt was cooled with cooling water at 30° C. The leaving solids were quite hot—above 50° C. Their longest dimension was up to 15 cm. The product was further crushed to an average size of 3 cm², in order to enable efficient packing .No dust or fine particles were observed. It is difficult to determine the shape of the crystals, due to their hygroscopity. It is clearly noted that while the flakes of the tetrahydrate are almost transparent, a small increase of the concentration of CaBr₂, e.g. 75% instead of 73.5%, yields crystals that are snow white but totally opaque. This phenomenon has no influence on the solubility or hygroscopicity of the solid and has no practical significance.

The following Examples illustrate the use the product of the invention.

### EXAMPLE 3

10 tons of depleted brine had to be upgraded to a specific gravity of 1.5. Said depleted brine has a specific gravity of 1.35 and contains 33% CaBr₂. The resulting brine with specific gravity of 1.5 contains 41% CaBr₂. One may operate according to either of two options.

Option 1—Using a standard 52% solution, with specific gravity of 1.71, 7.27 tons of said solution brine are needed to upgrade 10 tons of depleted brine and obtain 17.27 tons of brine having the desired specific gravity of 1.5.

Option 2—Using CaBr₂ tetrahydrate with 73.5% CaBr2, 2.5 ton of solid permit to obtain 12.5 tons of upgraded brine having the desired specific gravity.

It is seen that the amount of CaBr₂ tetrahydrate needed to upgrade the depleted brine is only ⅓ of the amount of 52% CaBr₂ solution that would be needed for the same purpose. This is an advantage, that is particularly important when the amount of said 52% solution is similar to or higher than the amount of the depleted brine.

### EXAMPLE 4

10 tons of brine with specific gravity of 1.61 are to be made using as raw material a depleted brine with a specific gravity of 1.25, a standard CaBr₂ solution and CaBr₂ tetrahydrate. Specific gravity of 1.25 corresponds to solution with 25% CaBr₂ and S.G. 1.6- to 47% CaBr₂. One may operate according to either of two options.

Option 1—Using a standard 52% CaBr₂ solution, with specific gravity of 1.71, 1.85 tons of depleted brine and 8.25 tons of said 52% CaBr₂ solution are needed.

Option 2—Using CaBr₂ tetrahydrate with 73.5% CaBr₂, 4.5 ton of depleted brine may be used—3 times more than when using the 52% solution.

As one can see, in option 1 the amount of CaBr₂ 52% exceeds by far the amount of the depleted brine, so that the upgrade is hardly practical. Using CaBr₂ tetrahydrate only a reasonable amount thereof is needed. The advantage is especially big when the real amount of solution needed for the application is similar to the amount of the depleted brine.

Herein, all specific gravities are calculated at 20° C. and all percentages are by weight. Fluids having specific gravities (S.G.) above 1.71 are considered herein as high density fluids.

As has been said, the density of Calcium Bromide solutions can be lowered by adding Calcium Chloride solution having a density of 11.8 ppg (a standard solution) or by adding water, and can be raised by adding Calcium Chloride Solid (94-97%) or Calcium Bromide Solid (above 95%). According to an aspect of the invention Calcium Bromide solutions, the density of which is too low for the intended use, e.g. depleted brines, is raised by the addition of Calcium Bromide Hydrate (65-78%). Calcium Bromide Hydrate can also be used, according to the invention, together with solid Calcium Chloride, Calcium Bromide solid or solution, to reduce the amount of said other additives to achieve a desired density. In the following Tables, the additive used to increase density is CaCl₂ Solid (Table 3) or CaBr₂ Hydrate (Table 4).

The following Table 3 illustrates the dependence of TCT, density and the volume increase of the returned fluid (14.2 ppg CaBr₂ which was reduced to 13 ppg by addition of CaCl₂ solution (11.8 ppg)). The density was corrected (raised) with CaCl₂ Solid. The units used in the Table can be converted as follows: to convert gr/ml to ppg, multiply by 8.33; to convert ml to gal, divide by 3780. As seen from Table 3, CaCl₂ Solid can be used to reach a density of about 1.59 gr/ml. However, at a density of about 1.61 gr/ml the TCT is 11.6° C., which would limit the fluid to use as summer blend only.

TABLE 3

| | Amount of | | | | |
|---|---|---|---|---|---|
| | CaCl₂ | Density, | | | |
| Volume of | Solid | S.G. | | | |
| returned | (gr) for | (gr/ml) | Volume | | |
| fluid | density | after | increase | | |
| (ml) | correction | correction | (ml) | TCT (° C.) | Comments |
| 1000 | — | 1.562 | — | <−15 | |
| 1000 | 156 | 1.5898 | 79.5 | −1.2 | |
| 1000 | 312 | 1.6113 | 162 | 11.6 | |
| 1000 | 468 | 1.6302 | 244 | 16.3 | |
| 1000 | 625 | — | — | — | Solubility* |
| | | | | | limitation |

*Solubiity limitation prevented the addition of more Calcium Chloride Solid

Table 4 is similar to Table 3, except that the density of the returned fluid was corrected (raised) with CaBr₂-Hydrate. A seen from Table 4, CaBr₂-Hydrate can be used to reach a density above 1.67 gr/ml and the TCT is still below zero, so that the returned fluid can be used as summer and winter blend.

TABLE 4

| | Amount of | | | | |
|---|---|---|---|---|---|
| | CaBr₂- | Density, | | | |
| Volume of | Hydrate | S.G. | | | |
| returned | (gr) for | (gr/ml) | Volume | | |
| fluid | density | after | increase | | |
| (ml) | correction | correction | (ml) | TCT (° C.) | Comments |
| 1000 | — | 1.562 | — | <−15 | |
| 1000 | 116.2 | 1.596 | 52.6 | −12.1 | |
| 1000 | 242 | 1.634 | 102 | −8.1 | |
| 1000 | 376 | 1.6702 | 160.6 | −3.3 | |
| 1000 | 507 | 1.7056 | 212.4 | 3.7 | |

Table 3 shows that 468 gr of Calcium Chloride Solid is needed to increase the density of 1000 gr of returned fluid to 1.63 gr/ml; the volume increase being 244 ml. Table 4 shows that 242 gr of Calcium Bromide Hydrate is needed to increase the density of 1000 gr of returned fluid to 1.63 gr/ml; the volume increase being 102 ml.

The Following Table 5 illustrates the dependence of TCT, density and the volume increase of the returned fluid (14.2 ppg CaBr₂ which was reduced to 13 ppg by addition of H₂O). The density was corrected (raised) with CaCl₂Solid. Table 5 shows that CaCl₂ Solid can be used to reach only about 1.63 gr/ml before precipitation begins. At this density the TCT is above zero and the fluid can only be used as a summer blend.

TABLE 5

| | Amount of | | | | |
|---|---|---|---|---|---|
| | CaCl₂ | Density, | | | |
| Volume of | Solid | S.G. | | | |
| returned | (gr) for | (gr/ml) | Volume | | |
| fluid | density | after | increase | | |
| (ml) | correction | correction | (ml) | TCT (° C.) | Comments |
| 1000 | — | 1.562 | — | <−19 | |
| 1000 | 250 | 1.604 | 129.6 | <−15 | |
| 1000 | 450 | 1.6308 | 162 | 6.1 | |
| 1000 | 625 | — | — | — | *Solubility |
| | | | | | limitation |

*Solubility limitation prevented the addition of more Calcium Chloride Solid

Table 6 is similar to Table 5, except that the density of the returned fluid was corrected (raised) with CaBr₂-Hydrate. Table 6 shows that CaBr₂-Hydrate can be used to reach the original density of 1.42 ppg (corresponding to 1.70 gr/ml). At this density, the TCT is below −15.6° C., which allows the fluid to be used as a summer and winter blend.

TABLE 6

| | Amount of | | | | |
|---|---|---|---|---|---|
| | CaBr₂- | Density, | | | |
| Volume of | Hydrate | S.G. | | | |
| returned | (gr) for | (gr/ml) | Volume | | |
| fluid | density | after | increase | | |
| (ml) | correction | correction | (ml) | TCT (° C.) | Comments |
| 1000 | — | 1.563 | — | <−19 | |
| 1000 | 58.1 | 1.581 | 24.6 | <−15.6 | + |
| 1000 | 116.8 | 1.599 | 49.3 | | |
| 1000 | 175.6 | 1.618 | 73.5 | | |
| 1000 | 256.7 | 1.639 | 106.2 | | |
| 1000 | 337.2 | 1.661 | 138.7 | | |
| 1000 | 418.3 | 1.683 | 171.9 | | |
| 1000 | 499.4 | 1.703 | 203.4 | −15.6 | |

+ The TCT is expected to be below −15.6° C., since the TCT of the concentrated solution was −15.6° C.

Different amounts of CaCl₂ Solid were added to Calcium Bromide 46% solution, which had an initial density of 1.56 gr/ml (13 ppg). The density of each fluid was corrected back to 13 ppg by addition of water. CaBr₂-Hydrate was then added to each fluid in order to raise the density to 1.42 ppg. The TCT of each fluid was then measured. The following Table 7 illustrates the effect of CaCl₂ concentration on the TCT of the returned fluid. Table 7 shows that the concentration of Calcium Chloride in the returned fluid, having density of 13 ppg, should not exceed approximately 6 wt %, since a higher concentration would result in a TCT close to or above zero, which would allow the fluid to be used only as a summer blend.

TABLE 7

| | | | |
|---|---|---|---|
| | | Density | |
| wt % CaCl₂ | TCT | (ppg) | comments |

| | | |
|---|---|---|
| 0 | −15.6 | 14.2 |
| 3.8 | −5.2 | 14.2 |
| 8.4 | −1 | 14.2 |
| 10.5 | 3.7 | 14.2 |
| 12 | 9.4 | 14.2 |

The graph of the drawing summarizes Tables 3 and 4. It shows that TCT is very dependent on CaCl₂ concentration. When CaCl₂ is used, densities above 1.59 gr/ml would result in high TCT, limiting the use of the fluid as a summer blend only. When CaBr₂ is used, the same limitation is reached with densities above 1.67 gr/ml, approximately 1.68-1.69. Calcium Bromide 52% solution cannot be used to reach the said densities (though it can be used to reach lower densities), because the volumes required would be too large, and therefore uneconomical and impractical. Calcium Bromide Hydrate, on the contrary, can be used.

While embodiments of the invention have been described by way of illustration, it will be understood that the invention may be carried into practice with many modifications, variations and adaptations, without departing from its spirit or exceeding the scope of the claims.

1. Process for manufacturing Calcium Bromide hydrates, which comprises preparing a highly concentrated Calcium Bromide solution from an initial solution having a lower concentration, bringing it into contact with a cold surface, whereby solid Calcium Bromide hydrates form on said surface, and detaching said solid hydrates from said surface.

2. Process according to claim 1, wherein the solution is an aqueous solution

3. Process according to claim 1, wherein the concentration of the initial Calcium Bromide solution is close to or equal to the saturation concentration.

4. Process according to claim 1, wherein the concentration of the initial Calcium Bromide solution is from 1 to 60 wt %.

5. Process according to claim 1, wherein the concentration of the initial Calcium Bromide solution is 52 wt %.

6. Process according to claim 1, wherein the temperature of the solid surface is from −15 to +40° C.

7. Process according to claim 1, wherein the concentration of the highly concentrated Calcium Bromide solution is from 65 to 78 wt %.

8. Process according to claim 1, wherein the temperature of the solid surface is from 5 to 25° C.

9. Process according to claim 1, wherein the solid surface is the surface of a body having any convenient structure.

10. Process according to claim 1, wherein the body is made of metal, such as non-iron metal, or polymer or rubber.

11. Process according to claim 10, wherein the metal is chosen from the group consisting of SS-steel, Monel, Titanium, and Hastelloy.

12. Process according to claim 9, wherein the body consists or one or more plates or one or more filaments or yarns.

13. Process according to claim 9, further comprising recovering and reusing the body after detaching the solid hydrates from it.

14. Process according to claim 1, wherein the Calcium Bromide hydrates are mainly tetrahydrate Calcium Bromide.

15. Solid CaBr₂ hydrate compositions having a concentration of said hydrates not less than 65 wt % and a density of not less than 2.1 gr/ml.

16. Solid CaBr₂ hydrate compositions according to claim 15 having a concentration of said hydrates from 65 to 78 wt % and a density from 2.1 to 2.3 gr/ml.

17. Solid CaBr₂ hydrate compositions according to claim 15 having a concentration of said hydrates from 70 to 75 wt % and a density from 2.15 to 2.3 gr/ml.

18. Solid CaBr₂ hydrate compositions according to claim 15, comprising only one hydrate.

19. Process for raising the density of Calcium Bromide solutions, in particular depleted brines, by adding Solid CaBr₂ hydrates to said solutions.

20. Process according to claim 19, further comprising adding to the Calcium Bromide solutions another density raising additive.

21. Process according to claim 20, wherein the other density raising additive is solid Calcium Chloride.

22. Use of Solid CaBr₂ hydrates for
(a.) the preparation of completion fluids, work-over fluids or drill-in fluids, in the processing of wells, and for soil remediation;
(b.) restoring already used and/or depleted completion fluids, work-over fluids or drill-in fluids to or close to the desired, original density, and for soil remediation; and/or
(c.) preparation of fluids having a density above 1.71 S.G. for use as completion fluids, work-over fluids or drill-in fluids in the processing of wells, and for soil remediation.

23. (canceled)

24. (canceled)

25. Completion fluids, work-over fluids or drill-in fluids, comprising dissolved CaBr₂ hydrates.

26. High density solid CaBr₂ hydrates for use in restoring already used and/or depleted completion fluids, work-over fluids or drill-in fluids to or close` to the desired, original density.
